(19) United States
(12) Patent Application Publication
(10) Pub. No.: US 2024/0319993 A1
(43) Pub. Date: Sep. 26, 2024

(54) CODE REFACTORING ENERGY MANAGEMENT

(71) Applicant: THE WEATHER COMPANY, LLC, Brookhaven, GA (US)

(72) Inventors: Andrew T. Penrose, Castleknock (IE); Jonathan D. Dunne, Dungarvan (IE); Marshall Allen Lamb, Raleigh, NC (US); James W Flynn, Medford, MA (US); Jason O'Leary, Methuen, MA (US)

(21) Appl. No.: 18/188,078

(22) Filed: Mar. 22, 2023

(51) Int. Cl. G06F 8/72; G06F 8/71

(52) U.S. Cl. CPC G06F 8/72; G06F 8/71

(57) ABSTRACT

Embodiments of the present invention provide computer-implemented methods, computer program products and computer systems. For example, embodiments of the present invention can, in response to receiving a request, create a power refactoring model for a codebase based on received telemetry data and static analysis of code within the codebase. Embodiments of the present invention can further optimize existing code regions within the codebase to function with less energy requirements using the created power refactoring model and replace existing code regions within the codebase with optimized code that functions with less energy requirements.

### BACKGROUND

The present invention relates generally to code refactoring, and more particularly to energy management with optimized code refactoring.

Continuous integration (CI) and continuous delivery (CD), also known as Cl/CD, typically embodies operating principles and a set of practices that application development teams use to deliver code changes more frequently and reliably.

Continuous integration refers to a coding philosophy and set of practices that drive development teams to frequently implement small code changes and check them in to a version control repository. Most modern applications require developing code using a variety of platforms and tools, so teams need a consistent mechanism to integrate and validate changes. Continuous integration establishes an automated way to build, package, and test their applications. Having a consistent integration process encourages developers to commit code changes more frequently, which leads to better collaboration and code quality.

Continuous delivery automates application delivery to selected environments, including production, development, and testing environments. Continuous delivery is an automated way to push code changes to these environments.

Microservices refer to an architectural style that structures an application as a collection of services that are independently deployable and loosely coupled. With a microservices architecture, an application is built as independent components that run each application process as a service. These services communicate via a well-defined interface using lightweight APIs. Services are built for business capabilities and each service performs a single function. Because they are independently run, each service can be updated, deployed, and scaled to meet demand for specific functions of an application.

### SUMMARY

According to an aspect of the present invention, there is provided a computer-implemented method. The computer implemented method comprises: in response to receiving a request, creating a power refactoring model for a codebase based on received telemetry data and static analysis of code within the codebase; optimizing existing code regions within the codebase to function with less energy requirements using the created power refactoring model; and replacing existing code regions within the codebase with optimized code that functions with less energy requirements.

### BRIEF DESCRIPTION OF THE DRAWINGS

Preferred embodiments of the present invention will now be described, by way of example only, with reference to the following drawings, in which:

FIG. 1 depicts a block diagram of a computing environment, in accordance with an embodiment of the present invention;

FIG. 2 is a flowchart depicting operational steps for reducing energy consumption levels using code refactoring, in accordance with an embodiment of the present invention;

FIG. 3 is a flowchart depicting operational steps for optimizing code regions, in accordance with an embodiment of the present invention; and

FIG. 4 is a flowchart depicting operational steps for a Continuous Integration/Continuous Delivery (CICD) pipeline, in accordance with an embodiment of the present invention; and

FIG. 5 is a block diagram of an alternate computing environment, in accordance with an embodiment of the present invention.

### DETAILED DESCRIPTION

Embodiments of the present invention recognize that in the field of Cloud computing, vendors and customers have migrated to a services-based architecture. Additionally, embodiments of the present invention recognize that machine learning and artificial intelligence help provide predictive methods to solve problems irrespective of their problem domain. Development of such solutions produce a pipeline of microservices and embody development practices related to Continuous Integration/Continuous Deployment (CICD).

Embodiments of the present invention further recognize that problems arise in the way such solutions are developed. For example, while the idea of microservice pipelines allows development teams to code solutions in heterogeneous languages, often times such solutions are developed using homogeneous languages which can create different energy requirements for the various functions of those microservice pipelines. Embodiments of the present invention recognize that not all languages consume system resources (e.g., CPU, Disk I/O and memory) at the same rate (e.g., the greater the system utilization the more power is consumed which drives cost upwards). As such, embodiments of the present invention create a power refactoring model that can analyze a solution codebase and determine what code can be refactored using a lower consumption development language or algorithm as discussed in greater detail, later in this Specification.

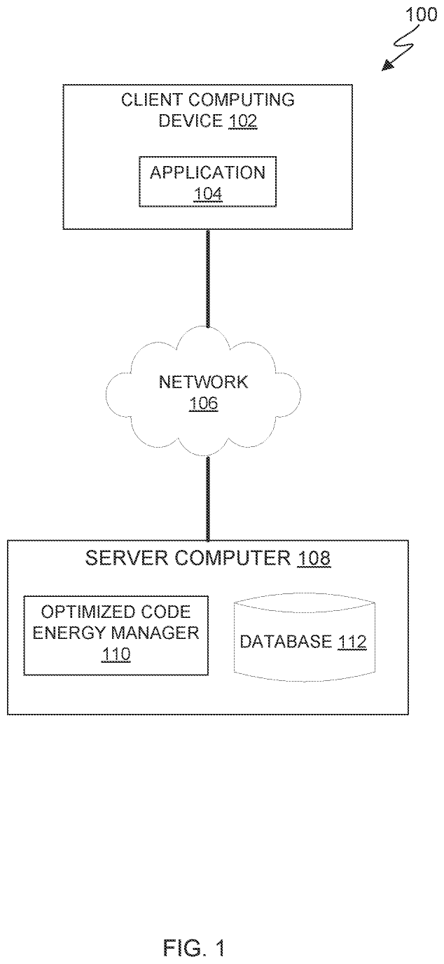

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 includes client computing device 102 and server computer 108, all interconnected over network 106. Client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computer as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 6.

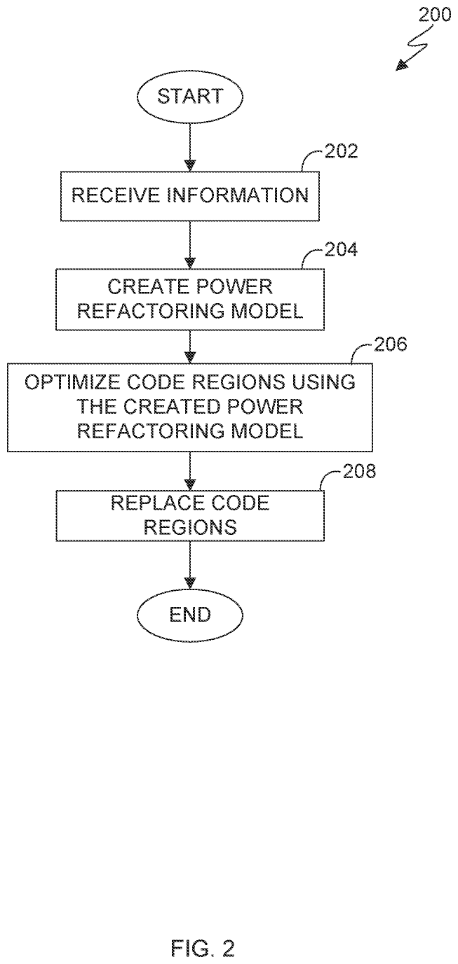

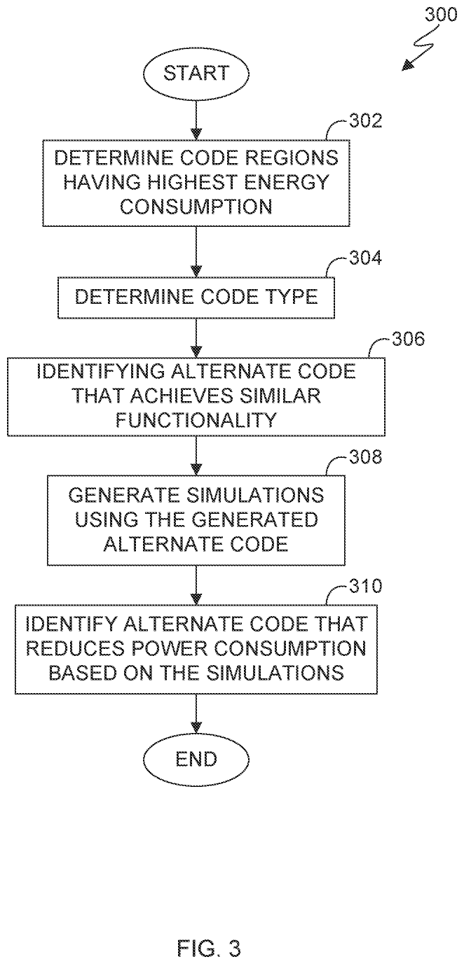

In this embodiment, client computing device 102 is a user device associated with a user and includes application 104. Application 104 communicates with server computer 108 to access optimized code energy manager 110 (e.g., using TCP/IP) to access code and database information. Application 104 can further communicate with optimized code energy manager 110 to optimize power consumption using code refactoring, as discussed in greater detail in FIGS. 2-3.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts optimized code energy manager 110 and database 112. In this embodiment, optimized code energy manager 110 resides on server computer 108. In other embodiments, optimized code energy manager 110 can have an instance of the program (not shown) stored locally on client computer device 102. In other embodiments, optimized code energy manager 110 can be a standalone program or system that can be integrated in one or more computing devices having a display screen.

Optimized code energy manager 110 creates a power refactoring model that can analyze a solution codebase and determine what code can be refactored using a lower consumption development language or algorithm. In this embodiment, optimized code energy manager 110 analyzes code bases of C# and Java. Optimized code energy manager 110 can also be used with additional languages outside of C# and Java (e.g., Python, R, Rust, go etc.) and as part of a CD/CI pipeline. In this embodiment, optimized energy manager 110 can monitor its own energy related metrics and make recommendations accordingly.

In this embodiment, optimized code energy manager 110 creates a power refactoring model by analyzing existing code compartments and infrastructure telemetry, deriving a power refactoring model based on identified code regions having the highest power consumption levels. In other words, optimized code energy manager 110 derives a power refactoring model to infer code regions that influence power consumption. In certain embodiments, optimized code energy manager 110 can additionally identify how often a piece of code may execute in a given period and adjust its recommendations accordingly. For example, optimized code energy manager 110 can de-prioritize replacing code that runs once a month for a reporting in favor of optimizing code that is determined to run millions of times per day. In other embodiments, optimized code energy manager 110 can reduce power consumption in a continuous delivery pipeline by identifying power hungry pull requests being delivered.

Optimized code energy manager 110 can then identify code types associates with those identified code regions having the highest power consumption levels. For example, identified code types can be public code or proprietary code. In instances where optimized code energy manager 110 identifies the code type of a code region to be public code, can simulate alternate code that performs the same function but requires lesser power (i.e., energy) consumption levels as discussed in greater detail with respect to FIGS. 2 and 3. In instances where optimized code energy manager 110 identifies the code type of a code region to be proprietary code, optimized code energy manager 110 can transmit a notification to the developer that there is an opportunity to experiment with alternative algorithms that would drive system utilization down. In other instances, optimized code energy manager 110 can generate recommendations for alternative algorithms that would reduce energy consumption levels. In other embodiments, optimized code energy manager 110 can simulate power consumption reduction based on a preferred language swap (e.g., Python to C).

Regardless of the code type, optimized code energy manager 110 identifies the language or algorithm with lowest simulated power output and passes that language or algorithm to a test build pipeline. Optimized code energy manager 110 can then produce a new test build cycle to determine respective power reduction of the proposed replacement code. Additionally, optimized code energy manager 110 can generate simulations to determine the power distribution pre- and post-refactoring to determine the probability that a change in power will prior any refactoring.

Optimized code energy manager 110 can then generalize the created power refactoring model across domain solution and base code types. In this way, optimized code energy manager 110 can create a knowledge base comprising code swaps of respective code types that are refactored across languages and domains.

Database 112 stores received information and store the created knowledge base. Database 112 can be representative of one or more databases that give permissioned access to optimized code energy manager 110 or publicly available databases. For example, database 112 can store performance data, records, transactions, etc. In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

FIG. 2 is a flowchart 200 depicting operational steps for reducing energy consumption levels using code refactoring, in accordance with an embodiment of the present invention.

In step 202, optimized code energy manager 110 receives information. Information received can include a request to perform an optimization of code that reduces power consumption. Information can also include information stored one or more databases (e.g., database 112) that store infrastructure telemetry data (i.e., performance data of any product). In this embodiment, telemetry data extends to and includes all logs, metrics, events and traces that are created by an microservice or other application.

In step 204, optimized code energy manager 110 creates a power refactoring model. In this embodiment, optimized code energy manager 110 creates a power refactoring model by analyzing the received information (e.g., logs, metrics, events, traces, etc.) using Gaussian Mixture modeling (e.g., to split the code into clusters).

Optimized code energy manager 110 further analyzes code of an application using static code analysis to identify and classify certain portions of code. In this embodiment, optimized code energy manager 110 may classify portions of code according to their function or reliability. For example, optimized code energy manager 110 classifies a portion of code as being reliable (e.g., safe pointer access). Other classifications can include faulty (e.g., out of bounds error), unused (e.g., unreachable code), unproven (e.g., may be unsafe in certain conditions, and a violation (e.g., MIRSA C/C++ or JSF++). In some embodiments, optimized code energy manager 110 can additionally identify how often a piece of code may execute in a given period and adjust its recommendations accordingly. For example, optimize code energy manager 110 can analyze code of an application and determine how frequently respective portions of code execute.

In step 206, optimized code energy manager 110 optimizes code regions using the created power refactoring model. In this embodiment, optimized code energy manager 110 optimizes existing code regions using the created power refactoring model by determining code regions having the highest power consumption levels, determining code type of the identified regions, generating alternate code that achieves similar functionality, generates simulations using the generated alternate code, and identifying alternate codes that have the highest reduction in power consumption as described in greater detail with respect to FIG. 3.

In step 208, optimized code energy manager 110 replaces existing code regions with the optimized code. In this embodiment, optimized code energy manager 110 replaces existing code regions with the optimize code and deploys the modified code. In some embodiments, optimized code energy manager 110 may build a test environment to test for code functionality.

FIG. 3 is a flowchart 300 depicting operational steps for optimizing code regions, in accordance with an embodiment of the present invention.

In step 302, optimized code energy manager 110 determines code regions having the highest power consumption levels. In this embodiment, optimized code energy manager 110 determines code regions having the highest power consumption levels using linear regression analysis. For example, optimized code energy manager 110 can use the following formula, Formula 1, described below:

$$y = a + {b}_{1} {x}_{1} + {b}_{2} {x}_{2} + {b}_{3} {x}_{3} + … {b}_{t} {x}_{t} + u \qquad Formula 1$$

where, “y” represents a regression formula that represents a line, “x represents variables, and “a” and “b” represent coefficients and “u” is a constant.

For example, optimized code energy manager 110 combines microservice code with a regression model to determine what code regions are influential on CPU, Disk and Memory consumption.

In step 304, optimized code energy manager 110 determines code type of the identified regions. In this embodiment, optimized code energy manager 110. In this embodiment, optimized code energy manager 110 determines code type of the identified regions having the highest power utilization using a decision tree algorithm. In other embodiments, optimized code energy manager 110 can determine code type by comparing portions of the identified code against a public database to verify whether those portions of code are generic. In instances where optimized code energy manager 110 cannot verify that those portions of code are generic, optimize code energy manager 110 can classify those portions of code as proprietary. In other embodiments, optimized code energy manager 110 can flag those portions of code as being potentially proprietary and solicit additional user feedback to confirm.

In step 306, optimized code energy manager 110 identifies alternate code that achieves similar functionality. In this embodiment, optimized code energy manager 110 identifies alternate code that achieves similar functionality by referencing public databases and identifying code languages that have similar function. In other words, optimized code energy manager 110 identifies an alternate, lower power language that can be used to replace the identified code. For example, optimized code energy manager 110 can identify an alternate code language and can identify portions of code within that language (i.e., alternate code implementations or alternate code suggestions) that achieve similar functionality from a stored repository of code languages using static analysis. In other embodiments, optimized code energy manager 110 can generate actual code using the identified alternate language. As used herein, codes having similar function refers to executed code that performs or achieves the intended outcome as the code it replaces. For example, where code specifies a function to “make left/top auto value consistent across browsers”, replacement code could be another code language that can achieve the same function (e.g., make left/top auto value consistent across browsers”) when the replacement code is substituted.

In another example, were optimized code energy manager 110 identifies code associated with the “make left/top auto value consistent between browsers” as being high power consumption, shown as Example 1 below:

Example 1: High Power Rating

```
Computed = curCSS ( elem prop );
  // if curCSS returns percentages, fallback to offset
  Return rnumonpx.test ( computed )?
```

Optimized code energy manager 110 can generate the following code to replace a code region that has a lower power rating, shown by Example 2 below:

Example 2: Low Power Rating Alternate Code

```
Var isAutoPosition,
  elStyles = gelStyles( elem ),
  position = curCSS ( elem, “position”, elStyles _;
computed = curCSS (eem, prop, elStyles );
isAutoPosition = computed ===” relative){
  return “0px;
}
```

In some embodiments, where optimized code energy manager 110 has access to or has created a shared knowledgebase of code types, code regions and replacements, optimized code energy manager 110 can generate alternate code that has been identified as alternate code that achieves similar functionality and can reduce power consumption levels.

In step 308, optimized code energy manager 110 generates simulations using the generated alternate code. In this embodiment, optimized code energy manager 110 generates simulations using the generated alternate code using a Monte Carlo simulation.

In step 310, optimized code energy manager 110 identifies alternate codes that have the highest reduction in power consumption. In this embodiment, optimized code energy manager 110 identifies alternate codes that have the highest reduction in power consumption based on the results of the Monte Carlo simulation. In instances where there are multiple alternate codes, optimized code energy manager 110 identifies the alternate code that has the highest reduction in power consumption (i.e., lowest power consumption).

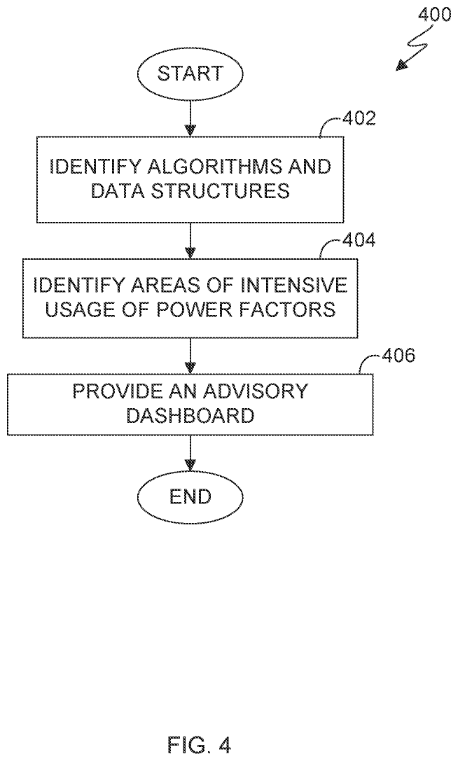

FIG. 4 is a flowchart 400 depicting operational steps for a Continuous Integration/Continuous Delivery (CICD) pipeline, in accordance with an embodiment of the present invention.

In step 402, optimized code energy manager 110 identifies algorithms and data structures. In this embodiment, optimized code energy manager 110 identifies algorithms and data structures at a microservices level through pull request delivery (e.g., pre or post-delivery).

In step 404, optimized code energy manager 110 identifies areas of intensive usage of power factors. In this embodiment, optimized code energy manager 110 identifies areas of intensive usage of power factors using the power refactoring model (e.g., that is built using the infrastructure telemetry, languages that were identified, and static analysis).

In step 406, optimized code energy manager 110 provides an advisory dashboard. An advisory dashboard as used herein refers to a user interface that displays one or more recommendations (e.g., alternate code having similar functionality and lower power consumption that can replace existing code). In this embodiment, optimized code energy manager 110 provides an advisory dashboard at different points in the pipeline (e.g., pull requests, pre-merge pipeline, merge pipeline, integration pipeline, staging pipeline, production pipeline) to provide insight into where improvements can be made both in early test environments and production systems depending on the load profiles used.

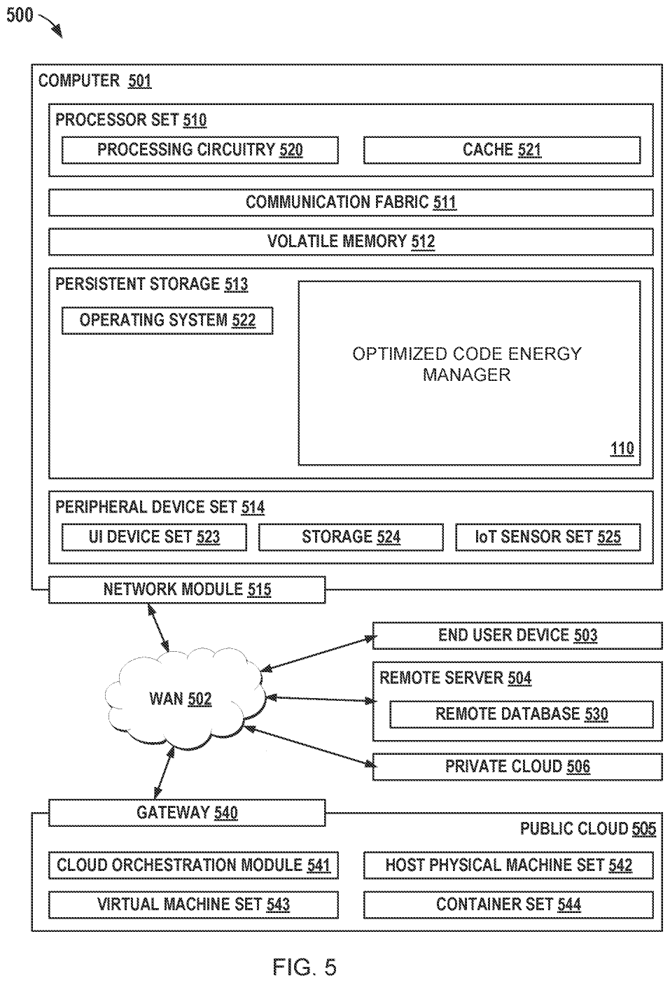

FIG. 5 depicts an alternate block diagram of components of computing systems within computing environment 100 of FIG. 1, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the inventive methods, such as optimized code energy manager 110 (also referred to as block 110) creates a power refactoring model that can analyze a solution codebase and determine what code can be refactored using a lower consumption development language or algorithm.

In addition to block 110, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 110, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 110 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in block 110 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

What is claimed is:

1. A computer-implemented method comprising:
in response to receiving a request, creating a power refactoring model for a codebase based on received telemetry data and static analysis of code within the codebase;
optimizing existing code regions within the codebase to function with less energy requirements using the created power refactoring model; and
replacing existing code regions within the codebase with optimized code that functions with less energy requirements.

2. The computer-implemented method of claim 1, wherein optimizing code regions within the codebase using the created power refactoring model comprises:
determining what code can be refactored using a lower consumption development language or algorithm; and
generating one or more alternate code implementations for the code that can be refactored.

3. The computer-implemented method of claim 2, wherein determining what code can be refactored using a lower consumption development language or algorithm comprises:
identifying code regions having highest power consumption; and
identifying code types of the identified code regions having the highest power consumption.

4. The computer-implemented method of claim 3, further comprising:
generating one or more simulations for the generated one or more alternate code implementations.

5. The computer-implemented method of claim 4, further comprising:
identifying an alternate code implementation of the generated one or more alternate code implementations having a lowest power consumption.

6. The computer-implemented method of claim 5, further comprising:
storing the identified alternate code implementation in a database comprising substituted code having low power consumption.

7. The computer-implemented method of claim 1, wherein a request comprises one or more pull requests in a continuous integration, continuous delivery (CICD) pipeline.

8. A computer program product comprising:
one or more computer readable storage media and program instructions stored on the one or more computer readable storage media, the program instructions comprising:
program instructions to, in response to receiving a request, create a power refactoring model for a codebase based on received telemetry data and static analysis of code within the codebase;
program instructions to optimize existing code regions within the codebase to function with less energy requirements using the created power refactoring model; and
program instructions to replace existing code regions within the codebase with optimized code that functions with less energy requirements.

9. The computer program product of claim 8, wherein the program instructions to optimize code regions within the codebase using the created power refactoring model comprise:
program instructions to determine what code can be refactored using a lower consumption development language or algorithm; and
program instructions to generate one or more alternate code implementations for the code that can be refactored.

10. The computer program product of claim 9, wherein the program instructions to determining what code can be refactored using a lower consumption development language or algorithm comprise:
program instructions to identify code regions having highest power consumption; and
program instructions to identify code types of the identified code regions having the highest power consumption.

11. The computer program product of claim 10, wherein the program instructions stored on the one or more computer readable storage media further comprise:
program instructions to generate one or more simulations for the generated one or more alternate code implementations.

12. The computer program product of claim 11, wherein the program instructions stored on the one or more computer readable storage media further comprise:
program instructions to identify an alternate code implementation of the generated one or more alternate code implementations having a lowest power consumption.

13. The computer program product of claim 12, wherein the program instructions stored on the one or more computer readable storage media further comprise:
program instructions to store the identified alternate code implementation in a database comprising substituted code having low power consumption.

14. The computer program product of claim 8, wherein a request comprises one or more pull requests in a continuous integration, continuous delivery (CICD) pipeline.

15. A computer system comprising:
one or more computer processors;
one or more computer readable storage media; and
program instructions stored on the one or more computer readable storage media for execution by at least one of the one or more computer processors, the program instructions comprising:
program instructions to, in response to receiving a request, create a power refactoring model for a codebase based on received telemetry data and static analysis of code within the codebase;
program instructions to optimize existing code regions within the codebase to function with less energy requirements using the created power refactoring model; and
program instructions to replace existing code regions within the codebase with optimized code that functions with less energy requirements.

16. The computer system of claim 15, wherein the program instructions to optimize code regions within the codebase using the created power refactoring model comprise:
program instructions to determine what code can be refactored using a lower consumption development language or algorithm; and
program instructions to generate one or more alternate code implementations for the code that can be refactored.

17. The computer system of claim 16, wherein the program instructions to determining what code can be refactored using a lower consumption development language or algorithm comprise:
program instructions to identify code regions having highest power consumption; and
program instructions to identify code types of the identified code regions having the highest power consumption.

18. The computer system of claim 17, wherein the program instructions stored on the one or more computer readable storage media further comprise:
program instructions to generate one or more simulations for the generated one or more alternate code implementations.

19. The computer system of claim 18, wherein the program instructions stored on the one or more computer readable storage media further comprise:
program instructions to identify an alternate code implementation of the generated one or more alternate code implementations having a lowest power consumption.

20. The computer system of claim 19, wherein the program instructions stored on the one or more computer readable storage media further comprise:
program instructions to store the identified alternate code implementation in a database comprising substituted code having low power consumption.
